(19) United States
(12) Patent Application Publication
(10) Pub. No.: US 2013/0006924 A1
(43) Pub. Date: Jan. 3, 2013

(54) SYSTEM AND METHOD OF ASSOCIATING AND MAINTAINING A PLURALITY OF CONTACTS STORED IN A PERSONAL INFORMATION MANAGER APPLICATION OF A PORTABLE ELECTRONIC DEVICE

(75) Inventors: Adrian Logan, Waterloo (CA); Neeraj Garg, Milton (CA)

(73) Assignee: RESEARCH IN MOTION LIMITED, Waterloo, ON (CA)

(21) Appl. No.: 13/635,142

(22) PCT Filed: Jan. 21, 2011
(86) PCT No.: PCT/CA2011/050035

§ 371 Date: Sep. 14, 2012

(51) Int. Cl. G06F 17/30

(52) U.S. Cl. 707/609; 707/E17.005

(57) ABSTRACT

A method of associating and maintaining a plurality of contacts stored in a personal information manager application of a portable electronic device, each of the plurality of contacts having a contact record including at least one contact record field. The method comprising associating the plurality of contacts based on a common contact record field to form a linked contact group; and upon modification of the common contact record field in one of the plurality of contacts in the linked contact group, automatically updating the common contact record field in all other contacts in the linked contact group.

### TECHNICAL FIELD

The present application relates to electronic devices that have personal information manager functionality or application and a method of associating multiple contacts stored in the personal information manager application of the electronic device based on a common contact record field and automatically maintaining the common contact record field of associated multiple contacts.

### BACKGROUND DISCUSSION

Electronic devices, including portable electronic devices, have gained widespread use and can perform a variety of functions including, for example, telephonic, electronic messaging and other personal information manager (PIM) application functions. Portable electronic devices can include several types of devices including mobile stations such as simple cellular telephones, smart telephones, wireless PDAs, and laptop computers with wireless 802.11 or 802.15 (for example, Bluetooth or ZigBee) capabilities. These devices run on a wide variety of networks from data-only networks such as Mobitex and DataTAC to complex voice and data networks such as GSM/GPRS, CDMA, EDGE, UMTS and CDMA2000 networks.

PIM applications permit storage and rendering of PIM records including, for example, contact data records or contact information. For example, a contact stored in the PIM application can have a contact data record including several contact record fields indicating the contact's name, address, phone number(s), email address, social network service information etc. Information stored in the contact record fields may be rendered for viewing or may be used for contacting a contact using the portable electronic device. It is imperative that the contact data records or contact information of a contact be current and not obsolete. Improved grouping, maintenance, and organization of contact information enhance the functionality of the PIM applications and also enhance user experience.

### BRIEF DESCRIPTION OF THE DRAWINGS

Embodiments of the present application will now be described, by way of example only, with reference to the attached Figures, wherein:

FIG. 1 is a block diagram of an example of an embodiment of a portable electronic device;

FIG. 2 is an example of a block diagram of a communication subsystem component of FIG. 1;

FIG. 3 is a block diagram of an example of an implementation of a node of a wireless network;

FIG. 4 is a block diagram illustrating components of an example of a configuration of a host system that the portable electronic device can communicate with;

FIGS. 5 to 12 show examples of screen shots of a portable electronic device;

FIG. 13 is a flowchart illustrating a method of associating and maintaining a plurality of contacts stored in a personal information manager application of a portable electronic device according to an example embodiment;

FIG. 14 is a flowchart illustrating a method of associating and maintaining a plurality of contacts stored in a personal information manager application of a portable electronic device according to another example embodiment; and,

FIG. 15 is a flowchart illustrating a method of associating and maintaining a plurality of contacts stored in a personal information manager application of a portable electronic device according to yet another example embodiment.

### DETAILED DESCRIPTION

The following describes a portable electronic device for and method of associating and maintaining a plurality of contacts stored in a personal information manager application of a portable electronic device. Each of the plurality of contacts has a contact record including at least one contact record field. The method includes associating the plurality of contacts based on a common contact record field to form a linked contact group; and upon modification of the common contact record field in one of the plurality of contacts in the linked contact group, automatically updating the common contact record field in all other contacts in the linked contact group.

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein. The example embodiments described herein generally relate to portable electronic devices. Examples of portable electronic devices include mobile or handheld wireless communication devices such as pagers, cellular phones, cellular smart-phones, wireless organizers, personal digital assistants, computers, laptops, handheld wireless communication devices, wirelessly enabled notebook computers and the like.

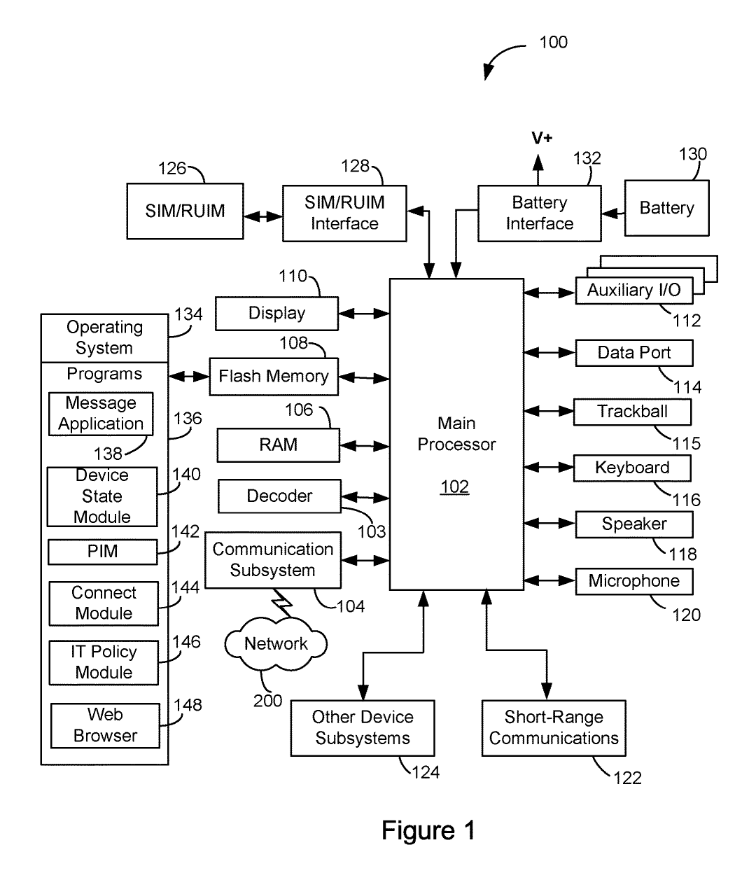

The portable electronic device may be a two-way communication device with advanced data communication capabilities including the capability to communicate with other portable electronic devices or computer systems through a network of transceiver stations. The portable electronic device may also have the capability to allow voice communication. Depending on the functionality provided by the portable electronic device, it may be referred to as a data messaging device, a two-way pager, a cellular telephone with data messaging capabilities, a wireless Internet appliance, or a data communication device (with or without telephony capabilities). To aid the reader in understanding the structure of the portable electronic device and how it communicates with other devices and host systems, reference will now be made to FIGS. 1 through 4.

Referring first to FIG. 1, shown therein is a block diagram of an example of an embodiment of a portable electronic device 100. The portable electronic device 100 includes a number of components such as a main processor 102 that controls the overall operation of the portable electronic device 100. Communication functions, including data and voice communications, are performed through a communication subsystem 104. Data received by the portable electronic device 100 can be decompressed and decrypted by a decoder 103, operating according to any suitable decompression techniques (e.g. YK decompression, and other known techniques) and encryption techniques (e.g. using an encryption technique such as Data Encryption Standard (DES), Triple DES, or Advanced Encryption Standard (AES)). The communication subsystem 104 receives messages from and sends messages to a wireless network 200. In this example of an embodiment of the portable electronic device 100, the communication subsystem 104 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is believed that they will have similarities to the network behavior described herein, and it will also be understood by persons skilled in the art that the example embodiments described herein are intended to use any other suitable standards that are developed in the future. The wireless link connecting the communication subsystem 104 with the wireless network 200 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 200 associated with portable electronic device 100 is a GSM/GPRS wireless network in one example of an implementation, other wireless networks may also be associated with the portable electronic device 100 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and third-generation (3G) networks such as EDGE and UMTS. Some other examples of data-centric networks include WiFi 802.11, 802.15, Mobitex™ and DataTAC™ network communication systems. Examples of other voice-centric data networks include Personal Communication Systems (PCS) networks like GSM and Time Division Multiple Access (TDMA) systems. The main processor 102 also interacts with additional subsystems such as a Random Access Memory (RAM) 106, a flash memory 108, a display 110, an auxiliary input/output (I/O) subsystem 112, a data port 114, a trackball 115, a keyboard 116, a speaker 118, a microphone 120, short-range communications 122 and other device subsystems 124.

Some of the subsystems of the portable electronic device 100 perform communication-related functions, whereas other subsystems may provide “resident” or on-device functions. By way of example, the display 110, the trackball 115 and the keyboard 116 may be used for both communication-related functions, such as entering a text message for transmission over the network 200, and device-resident functions such as a calculator or task list.

The portable electronic device 100 can send and receive communication signals over the wireless network 200 after network registration or activation procedures have been completed. Network access is associated with a subscriber or user of the portable electronic device 100. To identify a subscriber, a SIM/RUIM card 126 (i.e. Subscriber Identity Module or a Removable User Identity Module) is inserted into a SIM/RUIM interface 128 in order to communicate with a network. The SIM/RUIM card 126 is a type of a conventional “smart card” that can be used to identify a subscriber of the portable electronic device 100 and to personalize the portable electronic device 100, among other things. In the present example embodiment, the portable electronic device 100 is not fully operational for communication with the wireless network 200 without the SIM/RUIM card 126. By inserting the SIM/RUIM card 126 into the SIM/RUIM interface 128, a subscriber can access all subscribed services. Services may include: web browsing and messaging such as email, voice mail, Short Message Service (SMS), and Multimedia Messaging Services (MMS). More advanced services may include: point of sale, field service and sales force automation. The SIM/RUIM card 126 includes a processor and memory for storing information. Once the SIM/RUIM card 126 is inserted into the SIM/RUIM interface 128, it is coupled to the main processor 102. In order to identify the subscriber, the SIM/RUIM card 126 can include some user parameters such as an International Mobile Subscriber Identity (IMSI). An advantage of using the SIM/RUIM card 126 is that a subscriber is not necessarily bound by any single physical portable electronic device. The SIM/RUIM card 126 may store additional subscriber information for a portable electronic device as well, including datebook (or calendar) information and recent call information. Alternatively, user identification information can also be programmed into the flash memory 108.

The portable electronic device 100 is a battery-powered device and includes a battery interface 132 for receiving one or more rechargeable batteries 130. In at least some example embodiments, the battery 130 can be a smart battery with an embedded microprocessor. The battery interface 132 is coupled to a regulator (not shown), which assists the battery 130 in providing power V+ to the portable electronic device 100. Although current technology makes use of a battery, future technologies such as micro fuel cells may provide the power to the portable electronic device 100.

The portable electronic device 100 also includes an operating system 134 and software components 136 to 148 which are described in more detail below. The operating system 134 and the software components 136 to 148 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136 to 148, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications are installed on the portable electronic device 100 during its manufacture. Other software applications include a message application 138 that can be any suitable software program that allows a user of the portable electronic device 100 to send and receive electronic messages. Various alternatives exist for the message application 138 as is well known to those skilled in the art. Messages that have been sent or received by the user are typically stored in the flash memory 108 of the portable electronic device 100 or some other suitable storage element in the portable electronic device 100. In at least some example embodiments, some of the sent and received messages may be stored remotely from the device 100 such as in a data store of an associated host system that the portable electronic device 100 communicates with.

The software applications can further include a device state module 140, a Personal Information Manager (PIM) 142, and other suitable modules (not shown). The device state module 140 provides persistence, i.e. the device state module 140 ensures that important device data is stored in persistent memory, such as the flash memory 108, so that the data is not lost when the portable electronic device 100 is turned off or loses power.

The PIM 142 includes functionality for organizing and managing data items of interest to the user, such as, but not limited to, email, contact data records, calendar events, voice mails, appointments, and task items. PIM applications include, for example, calendar, address book, tasks and memo applications. The PIM applications have the ability to send and receive data items via the wireless network 200. PIM data items may be seamlessly integrated, synchronized, and updated via the wireless network 200 with the portable electronic device subscriber's corresponding data items stored and/or associated with a host computer system. This functionality creates a mirrored host computer on the portable electronic device 100 with respect to such items. This can be particularly advantageous when the host computer system is the portable electronic device subscriber's office computer system.

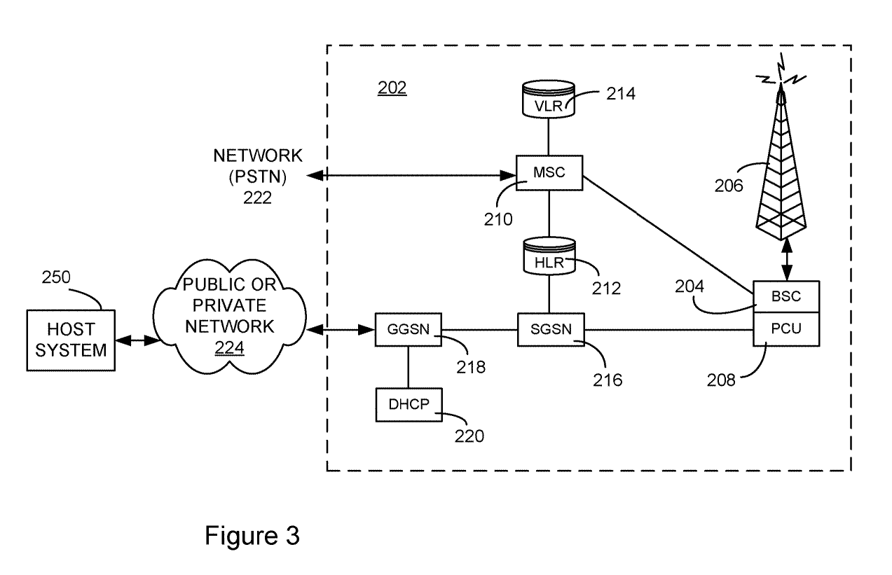

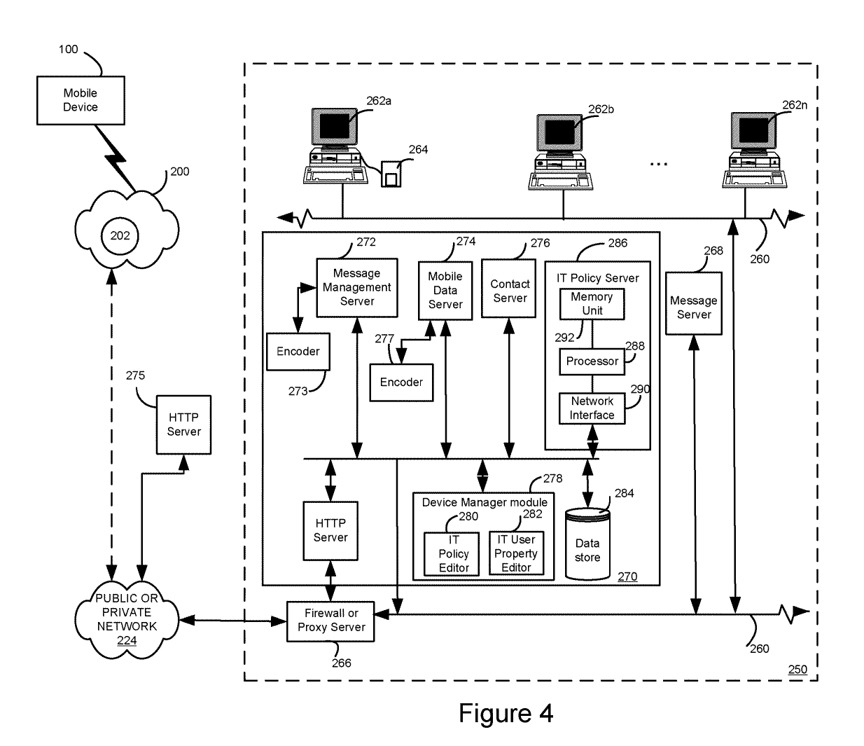

The portable electronic device 100 also includes a connect module 144, and an information technology (IT) policy module 146. The connect module 144 implements the communication protocols that are required for the portable electronic device 100 to communicate with the wireless infrastructure and any host system, such as an enterprise system, that the portable electronic device 100 is authorized to interface with. Examples of a wireless infrastructure and an enterprise system are given in FIGS. 3 and 4, which are described in more detail below.

The connect module 144 includes a set of APIs that can be integrated with the portable electronic device 100 to allow the portable electronic device 100 to use any number of services associated with the enterprise system. The connect module 144 allows the portable electronic device 100 to establish an end-to-end secure, authenticated communication pipe with the host system. A subset of applications for which access is provided by the connect module 144 can be used to pass IT policy commands from the host system to the portable electronic device 100. This can be done in a wireless or wired manner. These instructions can then be passed to the IT policy module 146 to modify the configuration of the device 100. Alternatively, in some cases, the IT policy update can also be done over a wired connection.

Other types of software applications can also be provided on the portable electronic device 100, including the Web browser 148 for enabling a user to display and interact with text, images, videos, music and other information from a webpage at a website on the World Wide Web or on a local network.

Still other types of software applications can be installed on the portable electronic device 100. Such software applications can be third party applications, which are added after the manufacture of the portable electronic device 100. Examples of third party applications include games, calculators, utilities, etc.

The additional applications can be loaded onto the portable electronic device 100 through at least one of the wireless network 200, the auxiliary I/O subsystem 112, the data port 114, the short-range communications subsystem 122, or any other suitable device subsystem 124. This flexibility in application installation increases the functionality of the portable electronic device 100 and may provide enhanced on-device functions, communication-related functions, or both. For example, secure communication applications may enable electronic commerce functions and other such financial transactions to be performed using the portable electronic device 100.

The data port 114 enables a subscriber to set preferences through an external device or software application and extends the capabilities of the portable electronic device 100 by providing for information or software downloads to the portable electronic device 100 other than through a wireless communication network. The alternate download path, for example, may be used to load an encryption key onto the portable electronic device 100 through a direct and thus reliable and trusted connection to provide secure device communication.

The data port 114 can be any suitable port that enables data communication between the portable electronic device 100 and another computing device. The data port 114 can be a serial or a parallel port. In some instances, the data port 114 can be a USB port that includes data lines for data transfer and a supply line that can provide a charging current to charge the battery 130 of the portable electronic device 100.

The short-range communications subsystem 122 provides for communication between the portable electronic device 100 and different systems or devices, without the use of the wireless network 200. For example, the subsystem 122 may include an infrared device and associated circuits and components for short-range communication. Examples of short-range communication standards include standards developed by the Infrared Data Association (IrDA), Bluetooth, and the 802.11 and 802.15 families of standards developed by IEEE.

In use, a received signal such as a text message, an email message, webpage download, or any other information is processed by the communication subsystem 104 and input to the main processor 102 where the received signal is processed for output to the display 110 or alternatively to the auxiliary I/O subsystem 112. A subscriber may also compose data items, such as email messages, for example, using the keyboard 116 in conjunction with the display 110 and possibly the auxiliary I/O subsystem 112. The auxiliary subsystem 112 may include devices such as: a touch screen, mouse, track ball, infrared fingerprint detector, or a roller wheel with dynamic button pressing capability. The keyboard 116 is preferably an alphanumeric keyboard and/or telephone-type keypad. However, other types of keyboards may also be used. A composed item may be transmitted over the wireless network 200 through the communication subsystem 104.

For voice communications, the overall operation of the portable electronic device 100 is substantially similar, except that the received signals are output to the speaker 118, and signals for transmission are generated by the microphone 120. Alternative voice or audio I/O subsystems, such as a voice message recording subsystem, can also be implemented on the portable electronic device 100. Although voice or audio signal output is accomplished primarily through the speaker 118, the display 110 can also be used to provide additional information such as the identity of a calling party, duration of a voice call, or other voice call related information.

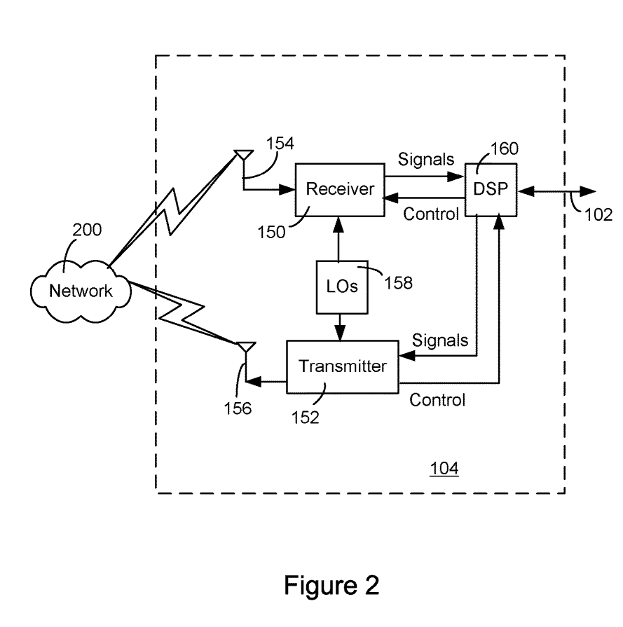

Referring now to FIG. 2, an example of a block diagram of the communication subsystem component 104 is shown. The communication subsystem 104 includes a receiver 150, a transmitter 152, as well as associated components such as one or more embedded or internal antenna elements 154 and 156, Local Oscillators (LOs) 158, and a processing module such as a Digital Signal Processor (DSP) 160. The particular design of the communication subsystem 104 is dependent upon the communication network 200 with which the portable electronic device 100 is intended to operate. Thus, it should be understood that the design illustrated in FIG. 2 serves only as one example.

Signals received by the antenna 154 through the wireless network 200 are input to the receiver 150, which may perform such common receiver functions as signal amplification, frequency down conversion, filtering, channel selection, and analog-to-digital (A/D) conversion. A/D conversion of a received signal allows more complex communication functions such as demodulation and decoding to be performed in the DSP 160. In a similar manner, signals to be transmitted are processed, including modulation and encoding, by the DSP 160. These DSP-processed signals are input to the transmitter 152 for digital-to-analog (D/A) conversion, frequency up conversion, filtering, amplification and transmission over the wireless network 200 via the antenna 156. The DSP 160 not only processes communication signals, but also provides for receiver and transmitter control. For example, the gains applied to communication signals in the receiver 150 and the transmitter 152 may be adaptively controlled through automatic gain control algorithms implemented in the DSP 160.

The wireless link between the portable electronic device 100 and the wireless network 200 can contain one or more different channels, typically different RF channels, and associated protocols used between the portable electronic device 100 and the wireless network 200. An RF channel is a limited resource that should be conserved, typically due to limits in overall bandwidth and limited battery power of the portable electronic device 100.

When the portable electronic device 100 is fully operational, the transmitter 152 is typically keyed or turned on only when it is transmitting to the wireless network 200 and is otherwise turned off to conserve resources. Similarly, the receiver 150 is periodically turned off to conserve power until it is needed to receive signals or information (if at all) during designated time periods.

Referring now to FIG. 3, a block diagram of an example of an implementation of a node 202 of the wireless network 200 is shown. In practice, the wireless network 200 includes one or more nodes 202. In conjunction with the connect module 144, the portable electronic device 100 can communicate with the node 202 within the wireless network 200. In the example of an implementation of FIG. 3, the node 202 is configured in accordance with General Packet Radio Service (GPRS) and Global Systems for Mobile (GSM) technologies. The node 202 includes a base station controller (BSC) 204 with an associated tower station 206, a Packet Control Unit (PCU) 208 added for GPRS support in GSM, a Mobile Switching Center (MSC) 210, a Home Location Register (HLR) 212, a Visitor Location Registry (VLR) 214, a Serving GPRS Support Node (SGSN) 216, a Gateway GPRS Support Node (GGSN) 218, and a Dynamic Host Configuration Protocol (DHCP) 220. This list of components is not meant to be an exhaustive list of the components of every node 202 within a GSM/GPRS network, but rather a list of components that are commonly used in communications through the network 200.

In a GSM network, the MSC 210 is coupled to the BSC 204 and to a landline network, such as a Public Switched Telephone Network (PSTN) 222 to satisfy circuit switched requirements. The connection through the PCU 208, the SGSN 216 and the GGSN 218 to a public or private network (Internet) 224 (also referred to herein generally as a shared network infrastructure) represents the data path for GPRS capable portable electronic devices. In a GSM network extended with GPRS capabilities, the BSC 204 also contains the Packet Control Unit (PCU) 208 that connects to the SGSN 216 to control segmentation, radio channel allocation and to satisfy packet switched requirements. To track the location of the portable electronic device 100 and availability for both circuit switched and packet switched management, the HLR 212 is shared between the MSC 210 and the SGSN 216. Access to the VLR 214 is controlled by the MSC 210.

The station 206 is a fixed transceiver station and together with the BSC 204 form fixed transceiver equipment. The fixed transceiver equipment provides wireless network coverage for a particular coverage area commonly referred to as a “cell”. The fixed transceiver equipment transmits communication signals to and receives communication signals from portable electronic devices within its cell via the station 206. The fixed transceiver equipment normally performs such functions as modulation and possibly encoding and/or encryption of signals to be transmitted to the portable electronic device 100 in accordance with particular, usually predetermined, communication protocols and parameters, under control of its controller. The fixed transceiver equipment similarly demodulates and possibly decodes and decrypts, if necessary, any communication signals received from the portable electronic device 100 within its cell. Communication protocols and parameters may vary between different nodes. For example, one node may employ a different modulation scheme and operate at different frequencies than other nodes.

For all portable electronic devices 100 registered with a specific network, permanent configuration data such as a user profile is stored in the HLR 212. The HLR 212 also contains location information for each registered portable electronic device and can be queried to determine the current location of a portable electronic device. The MSC 210 is responsible for a group of location areas and stores the data of the portable electronic devices currently in its area of responsibility in the VLR 214. Further, the VLR 214 also contains information on portable electronic devices that are visiting other networks. The information in the VLR 214 includes part of the permanent portable electronic device data transmitted from the HLR 212 to the VLR 214 for faster access. By moving additional information from a remote HLR 212 node to the VLR 214, the amount of traffic between these nodes can be reduced so that voice and data services can be provided with faster response times and at the same time requiring less use of computing resources.

The SGSN 216 and the GGSN 218 are elements added for GPRS support; namely packet switched data support, within GSM. The SGSN 216 and the MSC 210 have similar responsibilities within the wireless network 200 by keeping track of the location of each portable electronic device 100. The SGSN 216 also performs security functions and access control for data traffic on the wireless network 200. The GGSN 218 provides internetworking connections with external packet switched networks and connects to one or more SGSN's 216 via an Internet Protocol (IP) backbone network operated within the network 200. During normal operations, a given portable electronic device 100 must perform a “GPRS Attach” to acquire an IP address and to access data services. This requirement is not present in circuit switched voice channels as Integrated Services Digital Network (ISDN) addresses are used for routing incoming and outgoing calls. Currently, all GPRS capable networks use private, dynamically assigned IP addresses, thus requiring the DHCP server 220 connected to the GGSN 218. There are many mechanisms for dynamic IP assignment, including using a combination of a Remote Authentication Dial-In User Service (RADIUS) server and a DHCP server. Once the GPRS Attach is complete, a logical connection is established from a portable electronic device 100, through the PCU 208, and the SGSN 216 to an Access Point Node (APN) within the GGSN 218. The APN represents a logical end of an IP tunnel that can either access direct Internet compatible services or private network connections. The APN also represents a security mechanism for the network 200, insofar as each portable electronic device 100 must be assigned to one or more APNs and portable electronic devices 100 cannot exchange data without first performing a GPRS Attach to an APN that it has been authorized to use. The APN may be considered to be similar to an Internet domain name such as “myconnection.wireless.com”.

Once the GPRS Attach operation is complete, a tunnel is created and all traffic is exchanged within standard IP packets using any protocol that can be supported in IP packets. This includes tunneling methods such as IP over IP as in the case with some IPSecurity (IPsec) connections used with Virtual Private Networks (VPN). These tunnels are also referred to as Packet Data Protocol (PDP) Contexts and there are a limited number of these available in the network 200. To maximize use of the PDP Contexts, the network 200 will run an idle timer for each PDP Context to determine if there is a lack of activity. When a portable electronic device 100 is not using its PDP Context, the PDP Context can be de-allocated and the IP address returned to the IP address pool managed by the DHCP server 220.

Referring now to FIG. 4, shown therein is a block diagram illustrating components of an example of a configuration of a host system 250 that the portable electronic device 100 can communicate with in conjunction with the connect module 144. The host system 250 will typically be a corporate enterprise or other local area network (LAN), but may also be a home office computer or some other private system, for example, in variant implementations. In this example shown in FIG. 4, the host system 250 is depicted as a LAN of an organization to which a user of the portable electronic device 100 belongs. Typically, a plurality of portable electronic devices can communicate wirelessly with the host system 250 through one or more nodes 202 of the wireless network 200.

The host system 250 includes a number of network components connected to each other by a network 260. For instance, a user's desktop computer 262a with an accompanying cradle 264 for the user's portable electronic device 100 is situated on a LAN connection. The cradle 264 for the portable electronic device 100 can be coupled to the computer 262a by a serial or a Universal Serial Bus (USB) connection, for example. Other user computers 262b-262n are also situated on the network 260 and each may or may not be equipped with an accompanying cradle 264. The cradle 264 facilitates the loading of information (e.g. PIM data, private symmetric encryption keys to facilitate secure communications) from the user computer 262a to the portable electronic device 100, and may be particularly useful for bulk information updates often performed in initializing the portable electronic device 100 for use. The information downloaded to the portable electronic device 100 may include certificates used in the exchange of messages.

It will be understood by persons skilled in the art that the user computers 262a-262n will typically also be connected to other peripheral devices, such as printers etc., which are not explicitly shown in FIG. 4. Furthermore, only a subset of network components of the host system 250 are shown in FIG. 4 for ease of exposition, and it will be understood by persons skilled in the art that the host system 250 will include additional components that are not explicitly shown in FIG. 4 for this example of a configuration. More generally, the host system 250 may represent a smaller part of a larger network (not shown) of the organization, and may include different components and/or be arranged in different topologies than that shown in the example of an embodiment of FIG. 4.

To facilitate the operation of the portable electronic device 100 and the wireless communication of messages and message-related data between the portable electronic device 100 and components of the host system 250, a number of wireless communication support components 270 can be provided. In some implementations, the wireless communication support components 270 can include a management server 272, a mobile data server (MDS) 274, a web server, such as Hypertext Transfer Protocol (HTTP) server 275, a contact server 276, and a device manager module 278. HTTP servers can also be located outside the enterprise system, as indicated by the HTTP server 275 attached to the network 224. The device manager module 278 includes an IT Policy editor 280 and an IT user property editor 282, as well as other software components for allowing an IT administrator to configure the portable electronic devices 100. In an alternative example embodiment, there may be one editor that provides the functionality of both the IT policy editor 280 and the IT user property editor 282. The support components 270 also include a data store 284, and an IT policy server 286. The IT policy server 286 includes a processor 288, a network interface 290 and a memory unit 292. The processor 288 controls the operation of the IT policy server 286 and executes functions related to the standardized IT policy as described below. The network interface 290 allows the IT policy server 286 to communicate with the various components of the host system 250 and the portable electronic devices 100. The memory unit 292 can store functions used in implementing the IT policy as well as related data. Those skilled in the art know how to implement these various components. Other components may also be included as is well known to those skilled in the art. Further, in some implementations, the data store 284 can be part of any one of the servers.

In this example of an embodiment, the portable electronic device 100 communicates with the host system 250 through node 202 of the wireless network 200 and a shared network infrastructure 224 such as a service provider network or the public Internet. Access to the host system 250 may be provided through one or more routers (not shown), and computing devices of the host system 250 may operate from behind a firewall or proxy server 266. The proxy server 266 provides a secure node and a wireless internet gateway for the host system 250. The proxy server 266 intelligently routes data to the correct destination server within the host system 250.

In some implementations, the host system 250 can include a wireless VPN router (not shown) to facilitate data exchange between the host system 250 and the portable electronic device 100. The wireless VPN router allows a VPN connection to be established directly through a specific wireless network to the portable electronic device 100. The wireless VPN router can be used with the Internet Protocol (IP) Version 6 (IPV6) and IP-based wireless networks. This protocol can provide enough IP addresses so that each portable electronic device has a dedicated IP address, making it possible to push information to a portable electronic device at any time. An advantage of using a wireless VPN router is that it can be an off-the-shelf VPN component, and does not require a separate wireless gateway and separate wireless infrastructure. A VPN connection can preferably be a Transmission Control Protocol (TCP)/IP or User Datagram Protocol (UDP)/IP connection for delivering the messages directly to the portable electronic device 100 in this alternative implementation.

Messages intended for a user of the portable electronic device 100 are initially received by a message server 268 of the host system 250. Such messages may originate from any number of sources. For instance, a message may have been sent by a sender from the computer 262b within the host system 250, from a different portable electronic device (not shown) connected to the wireless network 200 or a different wireless network, or from a different computing device, or other device capable of sending messages, via the shared network infrastructure 224, possibly through an application service provider (ASP) or Internet service provider (ISP), for example.

The message server 268 typically acts as the primary interface for the exchange of messages, particularly email messages, within the organization and over the shared network infrastructure 224. Each user in the organization that has been set up to send and receive messages is typically associated with a user account managed by the message server 268. Some implementations of the message server 268 include a Microsoft Exchange™ server, a Lotus Domino™ server, a Novell Groupwise™ server, or another suitable mail server installed in a corporate environment. In some implementations, the host system 250 may include multiple message servers 268. The message server provides additional functions including PIM functions such as calendaring, contacts and tasks and supports data storage.

When messages are received by the message server 268, they are typically stored in a data store associated with the message server 268. In at least some example embodiments, the data store may be a separate hardware unit, such as data store 284, that the message server 268 communicates with. Messages can be subsequently retrieved and delivered to users by accessing the message server 268. For instance, an email client application operating on a user's computer 262a may request the email messages associated with that user's account stored on the data store associated with the message server 268. These messages are then retrieved from the data store and stored locally on the computer 262a. The data store associated with the message server 268 can store copies of each message that is locally stored on the portable electronic device 100. Alternatively, the data store associated with the message server 268 can store all of the messages for the user of the portable electronic device 100 and only a smaller number of messages can be stored on the portable electronic device 100 to conserve memory. For instance, the most recent messages (i.e. those received in the past two to three months for example) can be stored on the portable electronic device 100.

When operating the portable electronic device 100, the user may wish to have email messages retrieved for delivery to the portable electronic device 100. The message application 138 operating on the portable electronic device 100 may also request messages associated with the user's account from the message server 268. The message application 138 may be configured (either by the user or by an administrator, possibly in accordance with an organization's IT policy) to make this request at the direction of the user, at some pre-defined time interval, or upon the occurrence of some pre-defined event. In some implementations, the portable electronic device 100 is assigned its own email address, and messages addressed specifically to the portable electronic device 100 are automatically redirected to the portable electronic device 100 as they are received by the message server 268.

The management server 272 can be used to specifically provide support for the management of, for example, messages, such as email messages, that are to be handled by portable electronic devices. Generally, while messages are still stored on the message server 268, the management server 272 can be used to control when, if, and how messages are sent to the portable electronic device 100. The management server 272 also facilitates the handling of messages composed on the portable electronic device 100, which are sent to the message server 268 for subsequent delivery.

For example, the management server 272 may monitor the user's “mailbox” (e.g. the message store associated with the user's account on the message server 268) for new email messages, and apply user-definable filters to new messages to determine if and how the messages are relayed to the user's portable electronic device 100. The management server 272 may also, through an encoder 273, compress messages, using any suitable compression technology (e.g. YK compression, and other known techniques) and encrypt messages (e.g. using an encryption technique such as Data Encryption Standard (DES), Triple DES, or Advanced Encryption Standard (AES)), and push them to the portable electronic device 100 via the shared network infrastructure 224 and the wireless network 200. The management server 272 may also receive messages composed on the portable electronic device 100 (e.g. encrypted using Triple DES), decrypt and decompress the composed messages, re-format the composed messages if desired so that they will appear to have originated from the user's computer 262a, and re-route the composed messages to the message server 268 for delivery.

Certain properties or restrictions associated with messages that are to be sent from and/or received by the portable electronic device 100 can be defined (e.g. by an administrator in accordance with IT policy) and enforced by the management server 272. These may include whether the portable electronic device 100 may receive encrypted and/or signed messages, minimum encryption key sizes, whether outgoing messages must be encrypted and/or signed, and whether copies of all secure messages sent from the portable electronic device 100 are to be sent to a pre-defined copy address, for example.

The management server 272 may also be adapted to provide other control functions, such as only pushing certain message information or pre-defined portions (e.g. “blocks”) of a message stored on the message server 268 to the portable electronic device 100. For example, in some cases, when a message is initially retrieved by the portable electronic device 100 from the message server 268, the management server 272 may push only the first part of a message to the portable electronic device 100, with the part being of a pre-defined size (e.g. 2 KB). The user can then request that more of the message be delivered in similar-sized blocks by the management server 272 to the portable electronic device 100, possibly up to a maximum pre-defined message size. Accordingly, the management server 272 facilitates better control over the type of data and the amount of data that is communicated to the portable electronic device 100, and can help to minimize potential waste of bandwidth or other resources.

The MDS 274 encompasses any other server that stores information that is relevant to the corporation. The mobile data server 274 may include, but is not limited to, databases, online data document repositories, customer relationship management (CRM) systems, or enterprise resource planning (ERP) applications. The MDS 274 can also connect to the Internet or other public network, through HTTP server 275 or other suitable web server such as a File Transfer Protocol (FTP) server, to retrieve HTTP webpages and other data. Requests for webpages from the portable electronic device 100 are typically routed through MDS 274 and then to HTTP server 275, through suitable firewalls and other protective mechanisms. The web server then retrieves the webpage over the Internet, and returns it to MDS 274. As described above in relation to management server 272, MDS 274 is typically provided, or associated, with an encoder 277 that permits retrieved data, such as retrieved webpages, to be compressed, using any suitable compression technology (e.g. YK compression, and other known techniques), and encrypted (e.g. using an encryption technique such as DES, Triple DES, or AES), and then pushed to the portable electronic device 100 via the shared network infrastructure 224 and the wireless network 200.

The contact server 276 can provide information for a list of contact data records for the user in a similar fashion as the address book on the portable electronic device 100. Accordingly, for a given contact, the contact server 276 can include the name, phone number, work address and email address of the contact, among other information. The contact server 276 can also provide a global address list that contains the contact information for all of the contact data records associated with the host system 250.

It will be understood by persons skilled in the art that the management server 272, the MDS 274, the HTTP server 275, the contact server 276, the device manager module 278, the data store 284 and the IT policy server 286 do not need to be implemented on separate physical servers within the host system 250. For example, some or all of the functions associated with the management server 272 may be integrated with the message server 268, or some other server in the host system 250. Alternatively, the host system 250 may include multiple management servers 272, particularly in variant implementations where a large number of portable electronic devices need to be supported.

The device manager module 278 provides an IT administrator with a graphical user interface with which the IT administrator interacts to configure various settings for the portable electronic devices 100. As mentioned, the IT administrator can use IT policy rules to define behaviors of certain applications on the portable electronic device 100 that are permitted such as phone, web browser or Instant Messenger use. The IT policy rules can also be used to set specific values for configuration settings that an organization requires on the portable electronic devices 100 such as auto signature text, WLAN/VoIP/VPN configuration, security requirements (e.g. encryption algorithms, password rules, etc.), specifying themes or applications that are allowed to run on the portable electronic device 100, and the like.

As indicated above, the portable electronic device 100 includes the Personal Information Manager (PIM) 142 that includes functionality for organizing and managing data records of interest to the user, such as, but not limited to, email, contact data records, calendar events, voice mails, appointments, and task items. The data records are typically associated with contacts of the user of the portable electronic device. PIM applications include, for example, calendar, address book, tasks and memo applications. Additionally, the portable electronic device 100 includes functionality and is operable to send and receive PIN (Personal Identification Number) messages. PIN messages are messages that are relayed from the portable electronic device 100 for wireless delivery to a similarly enabled device identified by a unique number associated with the device. PIN messages may also be relayed from a similarly enabled device to the portable electronic device 100 identified by unique number. Thus, PIN messages are not transmitted to or through the host system 250.

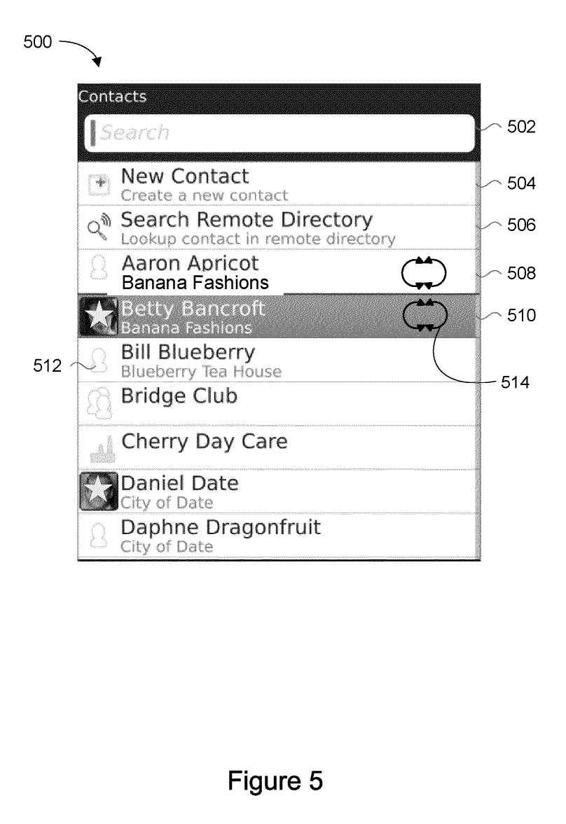

FIGS. 5 to 12 show examples of screen shots of the display 110 of the portable electronic device 100. As described above, the PIM 142 includes functionality for organizing and managing data items of interest to the user including contact data records. The contact data records may be stored locally in a contacts database on the SIM/RUIM card 126 at the portable electronic device 100 and may be retrieved for viewing and editing. Further, new contact data records may be composed and stored at the portable electronic device 100.

Throughout this description, a particular contact of interest to the user is referred to as a contact. Each contact has a contact record including at least one contact record field. For example, a contact of interest to the user can be an individual (another user), a group of individuals (e.g., a group of user sharing a common interest), an institution (e.g., service providers) and the like. The contact record of a contact can be identified by an identity tag and can include at least one of contact record information (or data) fields. For example, the contact record of an individual contact stored in the portable electronic device 100 can include contact record fields pertaining to the individual contact's name, company, job title, contact category (e.g., friend, family, work-related etc.), phone numbers, email addresses, and the like as described in detail below. In an example, the identity tag for a contact may be the first name, last name or a combination thereof as used in this description.

Selection of, for example, a contacts option or icon from a home screen on the portable electronic device 100, results in execution of a contacts application. Contact data records associated with contacts stored at the portable electronic device 100 are retrieved and rendered in a list on the display 110, such as the list 500 shown in FIG. 5. In the list view 500, a search bar 502 is provided readily search for and/or to retrieve a particular contact in the portable electronic device 100. Additionally, the list 500 includes options for adding or creating a new contact 504 and for searching for a contact in a remote directory 506.

In the present example, the contacts 508 are listed by first and last names only and are listed in alphabetical order. Optionally other or different information may be provided in the list 500. Further, the contacts may be listed in any suitable order. Each of the contacts in the list 500 is selectable by, for example, user scrolling to highlight a desired one of the contacts, followed by selection. A selected contact 510 may be highlighted as shown in FIG. 5 for ease of identification.

Furthermore, a suitable icon 512 may be associated with each contact for providing an identification of the type or category of the contact. In the present example, contacts Aaron Apricot, Bill Blueberry and Daphne Dragonfruit are shown as individual contacts; the contact Bridge Club is identified as a group contact; contact Cherry Day Care is represented by a suitable icon (work icon); while contacts Betty Bancroft and Daniel Date are identified with a photo icon.

In the following description, the method of associating and maintaining a plurality of contacts stored in a personal information manager application of a portable electronic device according to an example embodiment will be described using the contact data record associated with contact Betty Bancroft shown as the selected contact 510. A plurality of contacts can be associated with each other to form a linked contact group. In the example shown in FIG. 5, the contacts Aaron Apricot and Betty Bancroft are associated based on a common contact record field (e.g., both have a common contact record field “Banana Fashions”) and are linked to form a linked contact group, and identified by link identification icon 514.

It should be noted that contacts Aaron Apricot and Betty Bancroft are linked by a common contact record field (e.g., Company=Banana Fashions) and as such form a linked contact group. This link, on the basis of a common contact record field, can be considered as an internal link within the PIM application and is different from a group of contacts belonging to a particular category. For example, the Bridge Club contact group shown in FIG. 5 can include a number of contacts. The contacts within the Bridge Club grouping may or may not share a common contact record field and as such need not be linked to form a linked contact group.

A plurality of contacts can be associated with each other to form a linked contact group by a number of different ways. For example, when a new contact is added to the personal information manager application, the processor of the portable electronic device can be configured to automatically link contacts to form a linked contact group based on whether the new contact record includes any common contact record field with existing contacts within the PIM application.

When entering a new contact record, the processor can be configured to provide an option to import common contact record field(s) from existing contacts to avoid repetitive data entry and to enhance user experience. For example, if Betty Bancroft is an existing contact in the PIM application, and Aaron Apricot is being added as a new contact, the processor may automatically link the two contacts to form a linked contact group when the contact record field under Company is entered as “Banana Fashions” for Aaron Apricot and also import data associated with the company address, work phone etc. The processor may also provide an override option to prevent automatic data entry, for example, when Aaron Apricot is from a different location of Banana Fashions or has a different phone number.

The association of contacts to form a common linked group can be done manually as well. For example, when adding a new contact, the user may indicate that this contact shares common contact record field(s) with at least one existing contacts in the PIM application. The processor may be configured to then provide options to import common contact record field(s) for the new contact based on the contact record field(s) of the linked contacts.

As described earlier, each of the contacts in the list 500 is selectable, for example, by user scrolling to highlight a desired one of the contacts, followed by selection. In response to receiving the selection, further data form fields or contact record information (or data) fields of the selected one of the contacts is rendered.

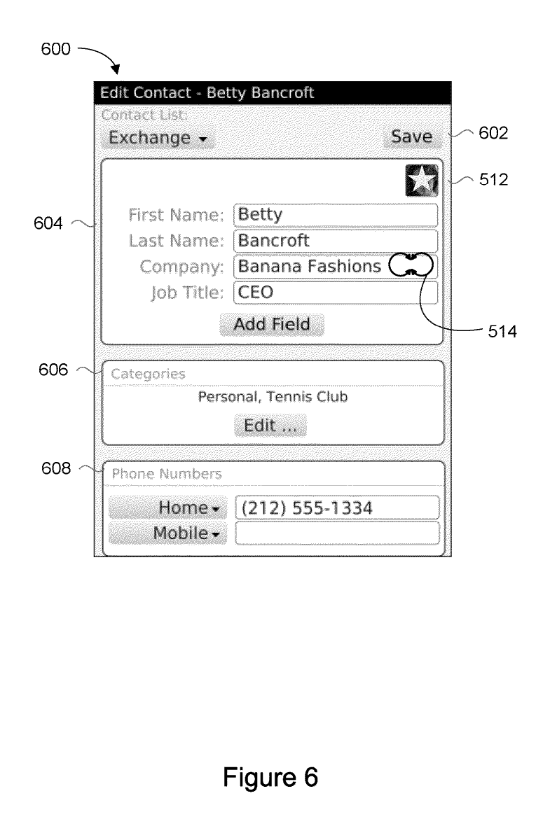

FIGS. 6 through 9 show an example of data rendered from a contact 510 after selection from the list 500. In the present example, the data is rendered as an edit list 600 for contact Betty Bancroft. The edit list 600 includes data from several fields of the contact record that can be edited and a save button or icon 602 to commit any changes made to the contact record. This includes data from fields such as a “First Name”; “Last Name”; “Company” and Job Title” commonly grouped together as contact identification information group 604 for displaying, for example, a first name, a last name, company, and job title and a picture icon 512 associated with contact Betty Bancroft. As Betty Bancroft's company information is linked to that of Aaron Apricot, the link identification icon 514 appears next to this field. The contact can be identified as a member of specific user-defined categories 606. For example, as shown at contact categories information group 606, Betty Bancroft belongs to “Personal” and “Tennis Club” categories. The telephone contact information or phone numbers information group 608 of Betty Bancroft includes “Home” and “Mobile” phone number data fields. As shown in FIG. 6, the home phone number data is available for Betty Bancroft, while the mobile phone number data is not available and may be entered in the edit list.

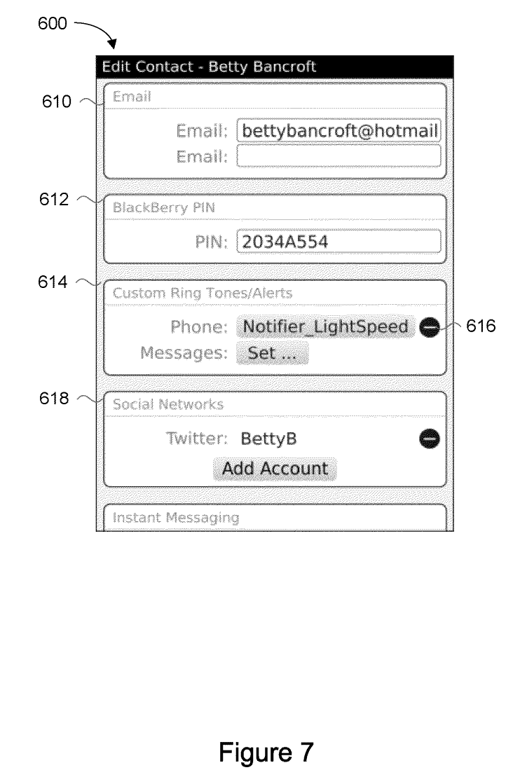

FIG. 7 is a continuation of the edit list 600 for contact Betty Bancroft and reveals additional information pertaining to this contact, which can be revealed or accessed by scrolling down from the view of FIG. 6. The email contact information group 610 of Betty Bancroft includes two email address data fields. As shown in FIG. 7, only one email address data is available for Betty Bancroft, while a second (or additional) email address data is not available and may be entered in the edit list.

A PIN contact information group 612 of contact Betty Bancroft includes a BlackBerry® PIN field and data associated with this field. Custom Ringtones and Alerts information group 614 for a contact can include data fields for phone, messages etc. As shown in FIG. 7, there is a custom ringtone associated with phone calls and there is no data associated with alerts for messages for contact Betty Bancroft. A “delete field” or “clear field” button 616 to delete or clear the data fields associated with each information group may also be provided. In other example embodiments, “minimize” or “hide” and “maximize” or “reveal” buttons to collapse or hide and expand or reveal the data fields associated with each information group may also be provided.

Social Networking Service (SNS) information group 618 pertaining to contact Betty Bancroft includes Twitter® account information. Additional SNS account fields, for example, facebook etc., may be added as required.

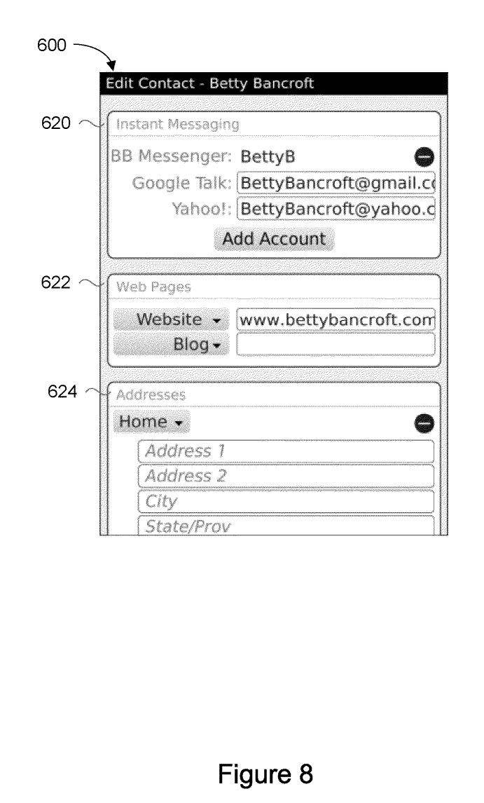

Scrolling down further on the edit list 600 reveals further information pertaining to Betty Bancroft as shown in FIG. 8. Instant Messaging (IM) information group 620 associated with contact Betty Bancroft includes data fields associated with communication applications such as BlackBerry® Messenger; Google™ Talk and Yahoo!®. Additional IM communication application information for the contact may be added, as desired.

Web pages and other online information group 622 pertaining to contact Betty Bancroft is shown next in the edit list 600. Website address data field is available for Betty Bancroft while a blog address data field is empty. This data may be entered from the edit list 600, if desired.

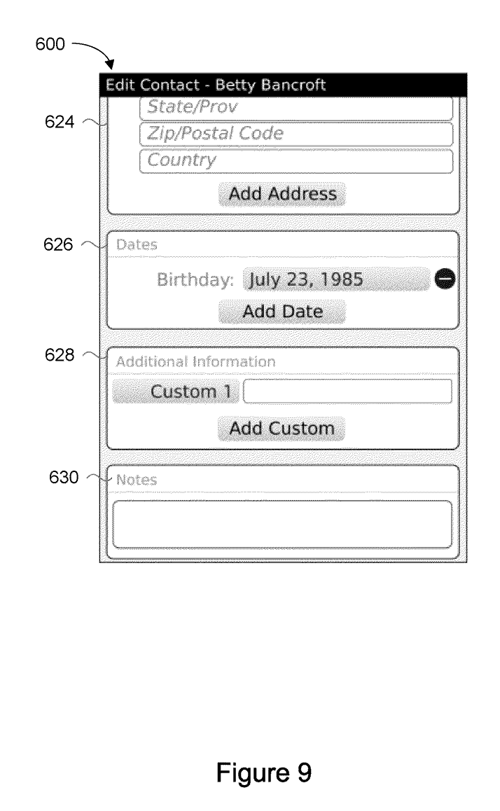

Address information group 624 associated with contact Betty Bancroft includes data field for Home address (including subfields for entering the home address) and are shown as an example in the edit list 600 of FIGS. 8 and 9. As shown in the edit list 600 of FIG. 9, additional address information may be added for the contact. Dates information group 626 provides a compilation of significant dates associated with contact Betty Bancroft. For example, Birthday data is available for Betty Bancroft and other significant dates may also be added, if desired.

Custom data fields may be created and added for contacts from the edit list 600 and are shown as additional information group 628 in FIG. 9. In this example, no custom information exists for contact Betty Bancroft. Also, a notes field 630 may be used to store relevant information pertaining to a contact. Again, in the example shown in FIG. 9, no notes information has been entered for contact Betty Bancroft.

The data displayed in each of these fields is stored in the contact record having a number of contact record information or data fields and may be edited or added in any suitable manner. The fields of the contact data record may be conveniently grouped together for improved organization of the contact data record as described above. It is noted that the grouping and data fields described above are by way of example only and additional data fields or different grouping may be readily provided and customized, as required. For example, further information may be added by, for example, scrolling to and selecting a data field or existing information may be removed by scrolling to and deleting the information associated with a data field.

The contact information may be stored on the portable electronic device 100 in any suitable manner. For example, the information associated with a contact may be stored on the SIM/RUIM card. Alternatively, the contact information may be stored in memory at the portable electronic device 100 and backed up at the host system. The information is added or edited by a user of the portable electronic device 100. The information may be displayed, for example, in response to receipt of selection of an option from a menu or submenu and may be added, deleted or otherwise edited. After adding, deleting or otherwise editing the user information, the user may save the changes, for example, by selection of an option to save from a menu.

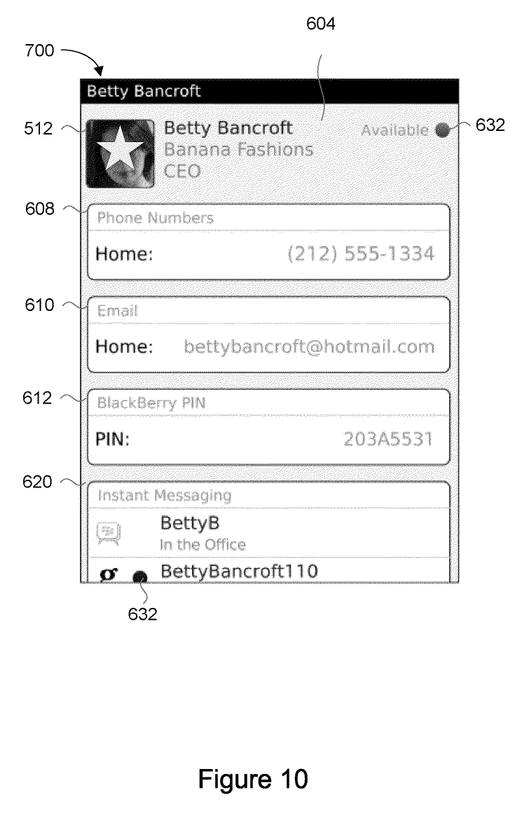

FIG. 10 shows one example of contact record 700 associated with contact Betty Bancroft stored on the portable electronic device 100 and includes information stored in various fields described with respect to FIGS. 6-9 that are conveniently grouped together for improved organization and visualization of the contact data record 700. The contact identification information group 604 identifies contact Betty Bancroft and provides her company and job title information along with a picture icon 512 associated with Betty Bancroft. The phone numbers associated with contact Betty Bancroft is shown in the phone numbers information group 608; the email contact information group 610 identifies her email address; the PIN contact information group 612 provides her BlackBerry® PIN number; the IM information group 620 includes the contact's BlackBerry® Messenger; Google™ Talk information along with a current status indicator 632 for an associated application.

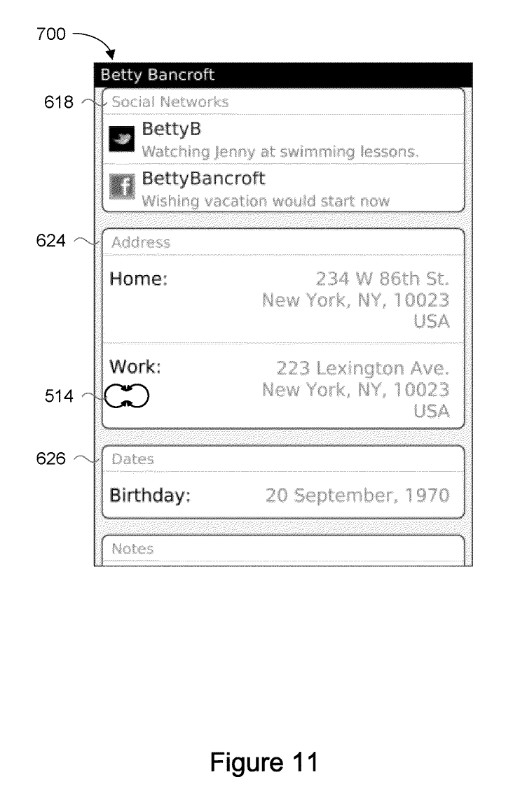

FIG. 11 shows a continuation of the contact record field 700 for contact Betty Bancroft which can be accessed, for example, by scrolling down the contact record field 700. The SNS information group lists Betty Bancroft's Twitter® and facebook account related information along with the current status for the associated application. The address information group 624 provides Betty Bancroft's home and work address information, while the dates information group 626 identifies Betty Bancroft's birthday. As Betty Bancroft's work address is linked to that of Aaron Apricot, the link identification icon 514 appears next to this field.

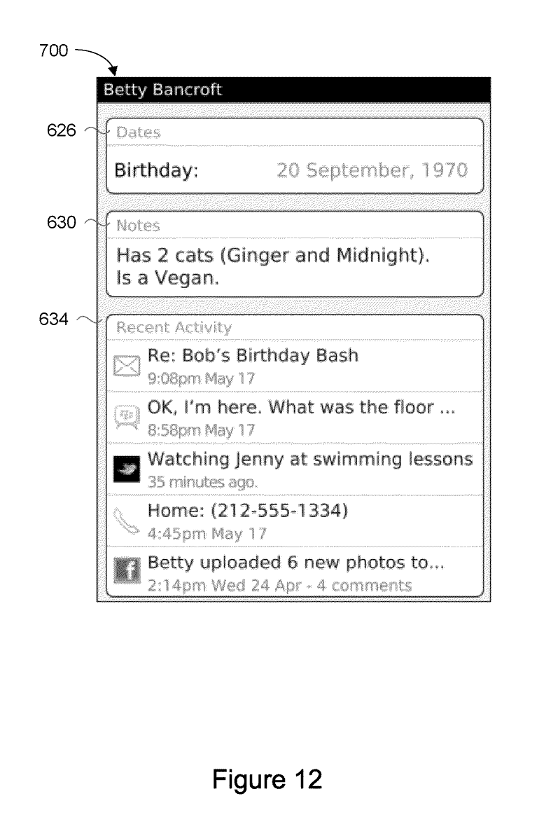

Scrolling down further on the contact record field 700 reveals further information pertaining to Betty Bancroft as shown in FIG. 12. The notes field 630 provides additional information pertaining to the contact.

The contact record field 700 shown in FIG. 12 also includes a Recent Activity information group 634 which includes a summary of recent activity associated with contact Betty Bancroft.

As described earlier, contacts Betty Bancroft and Aaron Apricot share a common contact record field in that they both are associated with Banana Fashions. Assuming Banana Fashions to be located only at a single location (no branch or multiple office locations), contacts Betty Bancroft and Aaron Apricot could then share common work address information as well. However, other contact information pertaining to Betty Bancroft and Aaron Apricot need not be common. For example, the home phone number, email addresses, PIN information, SNS information etc for Betty Bancroft and Aaron Apricot can be different. As such, Betty Bancroft and Aaron Apricot are linked to form a linked contact group based on the common company name and common company address contact record fields.

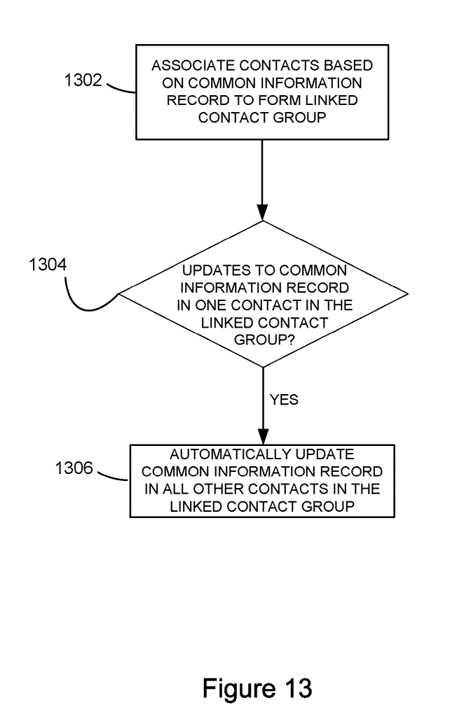

The method of associating and maintaining a plurality of contacts stored in a personal information manager application of a portable electronic device according to an example embodiment is illustrated by a flowchart in FIG. 13. As described earlier, each of the plurality of contacts has a contact record including at least one contact record field. The method includes associating the plurality of contacts based on a common contact record field to form a linked contact group at 1302. In the example described above, contacts Betty Bancroft and Aaron Apricot can be associated based on common company name and common company address contact record fields to form a linked contact group.

In order to maintain the common contact record field current and to avoid updating the common record field at multiple locations, the method automatically updates the common contact record field in all the contacts associated with the linked contact group as and when that common contact record field is modified in the contact record of any contact in the linked contact group. For example, upon modification of the common contact record field of the company address of Betty Bancroft at 1304, the PIM application 142 causes the processor 102 to automatically update the common contact record field in the contact record of Aaron Apricot as well at 1306. Thus, a modification of the common contact record field is automatically propagated to the contact records of all other contacts in the linked contact group to keep the common contact information current for all contacts sharing the common contact information.

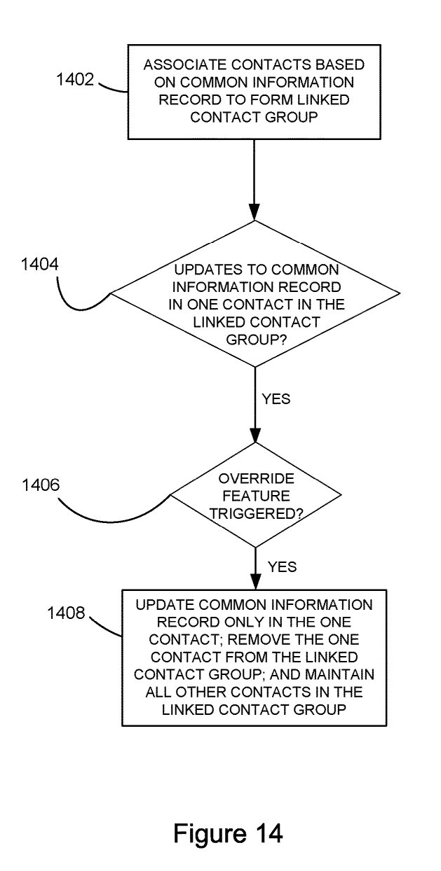

However, in a situation when a common contact record field ceases to be common, the linkage can be broken as well, as illustrated in the example embodiment shown in the flowchart of FIG. 14. As described earlier, Aaron Apricot and Betty Bancroft share a common contact record field (e.g., company name) and are hence associated based on the common contact record field to form a linked contact group at 1402. If Aaron Apricot ceases to be associated with Banana Fashions, and the contact record field associated with his company is modified at 1404, an override feature may be provided to the user such that upon triggering the override feature at 1406, the common contact record field for Aaron Apricot is updated without modifying the common contact record field for Betty Bancroft at 1408. (In an example embodiment, the override feature may be displayed to the user in the form of a pop-up window or other prompt which asks the user whether the common contact record field should be modified.) Thus, the linkage between contacts Aaron Apricot and Betty Bancroft is broken, while other contacts who are associated with Banana Fashions (not shown) may continue to share the common contact record field with each other and be linked in the linked contact group.

Typically, a contact record of a contact includes contact record fields associated with communication applications. The communication applications may include for example, data communication applications; voice communication applications; and multimedia message service (MMS) applications. The data communication applications may include electronic mail (email) applications; Short Message Service (SMS) applications; IM applications; and SNS applications. The voice communication applications may include telephone applications and voice SMS applications and the like.

For example, contacts Daniel Date and Daphne Dragonfruit shown in list 500 of FIG. 5 may share a common email address or a common home phone number. When an email or a phone call arrives from either one of the contacts, there may be uncertainty with respect to the contact name to be associated with the display of incoming email in the inbox or of the phone call in a caller ID display. Similarly, when a communication is sent to the common email address or a phone call is placed to the common home phone number, there may be uncertainty with respect to the display of the contact name in a recent activity screen.

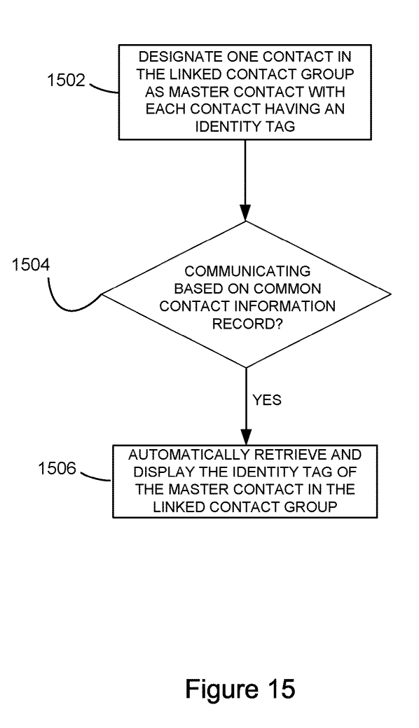

A solution is provided to the resolve the aforementioned uncertainty by providing a method according to an example embodiment illustrated by a flowchart in FIG. 15. As described earlier, each contact may be associated with an identity tag (e.g., first name or last name or a combination thereof). The method provides for designating one contact in the linked contact group as a master contact and uses the identity tag associated with the master contact to resolve the aforementioned uncertainties.

For example, in the linked contact group containing Daniel Date and Daphne Dragonfruit, Daniel Date may be designated as the master contact at 1502. When receiving a phone call from the common phone number shared between Daniel Date and Daphne Dragonfruit at 1504, the processor 102 is configured to automatically retrieve the identity tag associated with the master contact of the linked contact group for display at 1506. In this example, the Caller ID would display the name of Daniel Date (the identity tag of the master contact).

When a contact designated as the master contact for the linked contact group, is de-linked or removed to due modifications to the common contact record field, the processor may automatically designate or the user may manually designate another one of the plurality of contacts in the linked contact group as the master contact for the linked contact group. When the designation is made by the processor, the processor may base its decision on any number of factors such as, for example, designating the earliest contact created having the common contact record field as the master contact, designating the first contact in an alphabetical sorting of the contacts having the common contact record field as the master contact, or other usage heuristics such as designating the contact having the highest communication frequency with the user of the portable electronic device as the master contact etc. Of course, the master contact may be designated based on user preference as well.

According to another aspect, a portable electronic device is provided. The portable electronic device includes a display device, an input device, a memory unit, and a processor operably connected to the display device, the input device and the memory unit to execute a program stored in the memory unit to associate and maintain a plurality of contacts stored in a personal information manager application of the portable electronic device, each of the plurality of contacts having a contact record including at least one contact record field, the processor causing the portable electronic device to: associate the plurality of contacts based on a common contact record field to form a linked contact group; and upon modification of the common contact record field in one of the plurality of contacts in the linked contact group, automatically update the common contact record field in all other contacts in the linked contact group.

According to another aspect, a tangible computer program product is provided. The tangible computer program product includes non-transient computer-readable medium having computer-readable code embodied therein. The computer-readable code is executable by a processor of a portable electronic device to cause the portable electronic device to associate and maintain a plurality of contacts stored in a personal information manager application of the portable electronic device, each of the plurality of contacts having a contact record including at least one contact record field, the processor causing the portable electronic device to: associate the plurality of contacts based on a common contact record field to form a linked contact group; and upon modification of the common contact record field in one of the plurality of contacts in the linked contact group, automatically update the common contact record field in all other contacts in the linked contact group.

Thus, improved grouping and organization of contact information as described herein enhances the functionality of the PIM applications and also enhances user experience. Any updates to the common contact record field is automatically propagated to other contacts in the linked contact group without further user intervention thereby keeping the contact information current and preventing the information from becoming obsolete.

In the foregoing description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the example embodiments of the invention described herein are implemented as a software routine, hardware circuit, firmware, or a combination thereof.

Embodiments described herein may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an example embodiment. Those of ordinary skill in the art will appreciate that other instructions and operations necessary to implement the described example embodiments may also be stored on the machine-readable medium. Software running from the machine readable medium may interface with circuitry to perform the described tasks.

While the example embodiments described herein are directed to particular implementations of the electronic device and method of controlling the electronic device, the above-described embodiments are intended to be examples. Alterations, modifications and variations may be effected to the particular example embodiments by those of skill in the art without departing from the scope of the present disclosure.

1. A method of associating a plurality of contacts stored in a personal information manager application of a portable electronic device, each of the plurality of contacts having a contact record including at least one contact record field, the method comprising:
associating the plurality of contacts based on a common contact record field to form a linked contact group; and
upon modification of the common contact record field in one of the plurality of contacts in the linked contact group, updating the common contact record field in all other contacts in the linked contact group.

2. The method according to claim 1, further comprising:
designating one of the plurality of contacts in the linked contact group as a master contact for the linked contact group.

3. The method according to claim 2, wherein prior to updating the common contact record field in all other contacts in the linked contact group, the method further comprising:
providing an override feature to override the automatic updating of the common contact record field;
upon determining that the override feature has been triggered,
updating the common contact record field only in the one of the plurality of contacts; and,
removing the one of the plurality of contacts from the linked contact group while maintaining all other contacts in the linked contact group.

4. The method according to claim 3, wherein upon determining that the removed contact is the master contact for the linked contact group,
designating another one of the plurality of contacts in the linked contact group as the master contact for the linked contact group.

5. The method according to claim 4, wherein each of the plurality of contacts is associated with an identity tag.

6. The method according to claim 5, wherein the common contact record field is associated with a communication application installed on the portable electronic device, the method further comprising:
retrieving and displaying the identity tag of the master contact when communicating, based on the common contact record field, with any of the plurality of contacts in the linked contact group using the communication application.

7. The method according to claim 6, wherein the communication application installed on the portable electronic device includes data communication application; voice communication application; and multimedia message service (MMS) application.

8. The method according to claim 7, wherein the data communication application includes electronic mail (email) application; Short Message Service (SMS) application; Instant Message (IM) application; and Social Networking Service (SNS) application.

9. The method according to claim 7, wherein the voice communication application includes telephone application and voice SMS application.

10. The method according to claim 1, further comprising:
providing a linking icon indicating the common contact record field when displaying the contact record associated with any one of the plurality of contacts in the linked contact group.

11. The method according to claim 1, wherein a contact of the plurality of contacts is a member of more than one linked contact group.

12. A portable electronic device comprising:
a display;
a memory; and
a processor operably connected to the display, and the memory unit to execute a program stored in the memory unit to associate a plurality of contacts stored in a personal information manager application of the portable electronic device, each of the plurality of contacts having a contact record including at least one contact record field, the processor causing the portable electronic device to:
associate the plurality of contacts based on a common contact record field to form a linked contact group; and
upon modification of the common contact record field in one of the plurality of contacts in the linked contact group, update the common contact record field in all other contacts in the linked contact group.

13. The portable electronic device according to claim 12, wherein the processor is configured to designate one of the plurality of contacts in the linked contact group as a master contact for the linked contact group.

14. The portable electronic device according to claim 13, wherein prior to updating the common contact record field in all other contacts in the linked contact group, the processor is configured to:
provide an override feature to override the automatic updating of the common contact record field; and,
upon determining that the override feature has been triggered,
update the common contact record field only in the one of the plurality of contacts; and,
remove the one of the plurality of contacts from the linked contact group while maintaining all other contacts in the linked contact group.

15. The portable electronic device according to claim 14, wherein upon determining that the removed contact is the master contact for the linked contact group, the processor is configured to designate another one of the plurality of contacts in the linked contact group as the master contact for the linked contact group.

16. The portable electronic device according to claim 15, wherein each of the plurality of contacts is associated with an identity tag stored in the memory unit.

17. The portable electronic device according to claim 16, wherein the common contact record field is associated with a communication application installed on the portable electronic device, and the processor is configured to retrieve and display the identity tag of the master contact when communicating, based on the common contact record field, with any of the plurality of contacts in the linked contact group using the communication application.

18. The portable electronic device according to claim 16, wherein the communication application installed on the portable electronic device includes data communication application; voice communication application; and multimedia message service (MMS) application.

19. The portable electronic device according to claim 12, wherein the processor is configured to provide a linking icon indicating the common contact record field when displaying the contact record associated with any one of the plurality of contacts in the linked contact group.

20. A tangible computer program product comprising non-transient computer-readable medium having computer-readable code embodied therein executable by a processor of a portable electronic device to associate a plurality of contacts stored in a personal information manager application of the portable electronic device, each of the plurality of contacts having a contact record including at least one contact record field, the processor causing the portable electronic device to:
associate the plurality of contacts based on a common contact record field to form a linked contact group; and
upon modification of the common contact record field in one of the plurality of contacts in the linked contact group, update the common contact record field in all other contacts in the linked contact group.
